(19) United States
(12) Patent Application Publication
(10) Pub. No.: US 2020/0059168 A1
(43) Pub. Date: Feb. 20, 2020

(54) CAPACITIVE ALTERNATOR

(71) Applicant: POSITIVE ELECTRON CO., Bozeman, MT (US)

(72) Inventor: Andrew P. Ward, Bozeman, MT (US)

(21) Appl. No.: 16/543,312

(22) Filed: Aug. 16, 2019

Related U.S. Application Data
(60) Provisional application No. 62/719,028, filed on Aug. 16, 2018.
(60) Provisional application No. 62/736,894, filed on Sep. 26, 2018.

(51) Int. Cl. H02N 1/08; H01G 5/01; H02N 1/00

(52) U.S. Cl. CPC H02N 1/08; H02N 1/004; H01G 5/01

(57) ABSTRACT

A capacitive alternator is disclosed. The capacitive alternator includes a frame with a shaft rotatably coupled to and extending through the frame. The capacitive alternator includes a stator housed within the frame. The stator includes a plurality of stator electrodes arranged in respective first and second stator assemblies. The stator electrodes in the respective stator assemblies are in electrical communication with one another. The capacitive alternator includes a rotor supported on and fixedly attached to the shaft such that a rotation of the shaft causes a corresponding rotation of the rotor. The rotor includes a dipole assembly, including a first dipole electrode, and a second dipole electrode. The first and second dipole electrodes are electrically isolated from one another, from the shaft, and from the stator electrodes. The dipole assembly is rotatable relative to one of the plurality of stator electrodes.

### CROSS REFERENCE TO RELATED APPLICATIONS

This application claims the benefit of priority pursuant to 35 U.S.C. § 119(e) of U.S. provisional patent application No. 62/719,028, filed 16 Aug. 2018, entitled “Capacitive Alternator,” and U.S. provisional patent application No. 62/736,894, filed 26 Sep. 2018, entitled “Rotating Electric Field Alternating Current Generator,” which are hereby incorporated by reference herein in their entireties.

### TECHNICAL FIELD

The present disclosure relates to electrical power conversion devices. More particularly, the disclosure is directed to devices and methods for converting electrical charge or energy from one form to another through the use of a capacitive alternator.

### BACKGROUND

Alternators that rely on magnets to induce a current in a conductor are well known in the art. However, these devices have certain disadvantages such as, but not limited to, cost, weight, and the scarcity of highly magnetic materials. Therefore a solution is desired that enables conversion of electrical energy that does not rely on magnets.

### SUMMARY

A capacitive alternator is disclosed. The capacitive alternator includes a frame with a shaft rotatably coupled to and extending through the frame. The capacitive alternator includes a stator housed within the frame. The stator includes a plurality of stator electrodes arranged in a first stator assembly and a second stator assembly such that the stator electrodes in the first stator assembly are in electrical communication with one another. The stator electrodes in the second stator assembly are in electrical communication with one another. The capacitive alternator includes a rotor supported on and fixedly attached to the shaft such that rotation of the shaft causes a corresponding rotation of the rotor. The rotor includes a dipole assembly, with a first dipole electrode, and a second dipole electrode. The first and second dipole electrodes are electrically isolated from one another, from the shaft, and from the stator electrodes. The dipole assembly is rotatable relative to one of the plurality of stator electrodes.

A method of using a capacitive alternator to measure a rotational parameter of a shaft is disclosed. The method includes supplying a capacitive alternator. The capacitive alternator includes a frame, with a shaft rotatably coupled to and extending through the frame. The capacitive alternator includes a stator housed within the frame. The stator includes a plurality of stator electrodes arranged in a first stator assembly and a second stator assembly, such that the stator electrodes in the first stator assembly are in electrical communication with one another. The stator electrodes in the second stator assembly are in electrical communication with one another. A rotor is supported on and fixedly attached to the shaft such that rotation of the shaft causes a corresponding rotation of the rotor. The rotor includes a dipole assembly, which includes a first dipole electrode, and a second dipole electrode. The first and second dipole electrodes are electrically isolated from one another, from the shaft, and from the stator electrodes. The dipole assembly is rotatable relative to one of the plurality of stator electrodes, a first output electrode in electrical communication with the first stator assembly, and a second output electrode in electrical communication with the second stator assembly. The method includes rotating the shaft and measuring an electrical parameter of an output waveform between the first output electrode and the second output electrode, and correlating the electrical parameter to the rotational parameter.

### BRIEF DESCRIPTION OF THE DRAWINGS

FIG. 1 is a top view of an embodiment of a capacitive alternator;

FIG. 2 is a partial section view of the embodiment of a capacitive alternator of FIG. 1 taken along section line 2-2, showing a dipole assembly;

FIG. 3 is a partial section view of the embodiment of a capacitive alternator of FIG. 1 taken along section line 3-3, showing a dipole assembly in relation to stator electrodes;

FIG. 4 is a partial section view of the embodiment of a capacitive alternator of FIG. 1 taken along section line 4-4 of FIG. 3, showing a top view of a dipole assembly in relation to stator electrodes;

FIG. 5 is a partial section view of an embodiment of a capacitive alternator taken, showing a top view of a dipole assembly in relation to insulated stator electrodes.

FIG. 6 is a partial front view of an embodiment of a dipole assembly of an embodiment of a capacitive alternator;

FIG. 7 is a partial isometric view of the dipole assembly of FIG. 6;

FIG. 8 is a partial rear view of the dipole assembly of FIG. 6;

FIG. 9 is a partial rear view of the dipole assembly of FIG. 6;

FIG. 10 is a partial isometric view of the dipole assembly of FIG. 6;

FIG. 11 is a partial isometric view of the dipole assembly of FIG. 6;

FIG. 12 is a partial side view of the dipole assembly of FIG. 6;

FIG. 13 is a partial rear view of the dipole assembly of FIG. 6;

FIG. 14 is a partial front view of the dipole assembly of FIG. 6;

FIG. 15 is a partial side view of the dipole assembly of FIG. 6;

FIG. 16 is a partial top view of the dipole assembly of FIG. 6;

FIG. 17 is a partial schematic view of a system including a capacitive alternator;

FIG. 18 is a partial front view of an embodiment of a dipole assembly of an embodiment of a capacitive alternator.

FIG. 19 is a partial top view of the dipole assembly of FIG. 18.

FIG. 20 is a partial isometric view of the dipole assembly of FIG. 18.

FIG. 21 is an equivalent circuit of a rotating electric field alternating current generator;

FIG. 22A is a display of the output of a simulation of the equivalent circuit of FIG. 21 showing the power in a portion of the equivalent circuit;

FIG. 22B is a display of the output of a simulation of the equivalent circuit of FIG. 21 showing the power in a portion of the equivalent circuit;

FIG. 22C is a display of the output of a simulation of the equivalent circuit of FIG. 21 showing a comparison of power in portions of the equivalent circuit;

FIG. 23A is a display of the output of a simulation of the equivalent circuit of FIG. 21 showing current in the primary circuit;

FIG. 23B is a display of the output of a simulation of the equivalent circuit of FIG. 21 showing current in the secondary circuit;

FIG. 24A is a display of the output of a simulation of the equivalent circuit of FIG. 21 showing voltage in the primary circuit;

FIG. 24B is a display of the output of a simulation of the equivalent circuit of FIG. 21 showing voltage in the secondary circuit;

FIG. 25A is a display of the output of a simulation of the circuit of FIG. 25B showing power in portions of the circuit;

FIG. 25B is a schematic representing a resonant circuit;

FIG. 25C is a display of the output of a simulation of the circuit of FIG. 25D showing power in portions of the circuit;

FIG. 25D is a schematic representing a resonant circuit.

### DETAILED DESCRIPTION

Without being limited to any mechanism or mode of action the capacitive alternator disclosed may operate according to the following principles.

The present disclosure relates generally to devices, systems, and methods for converting electrical energy from one form to another using a capacitive alternator, also referred to as a rotating electric field alternating current generator. A capacitive alternator includes a rotor and a stator. The rotor includes one or more dipole assemblies that rotate about an axis, for example via a shaft, relative to the stator. An input torque is applied to the shaft, causing the dipole assemblies to rotate. The stator includes one or more stator electrodes that are adjacent to a dipole assembly. In some embodiments, one or more dipole assemblies are interleaved between one or more stator electrodes. The dipole assemblies and stator electrodes can be housed in a common frame, case, foundation or shell.

A dipole assembly includes one or more dipole electrodes and a rotatable portion that enables the dipole assembly to rotate about an axis. The dipole electrodes of a given dipole assembly are electrically isolated from one another by an electrical insulating material, and/or by a gap filled with a fluid. In some embodiments, an insulating gap can be under a vacuum where the partial pressure of a fluid filling the gap is de minimus. The respective dipole electrodes can be charged with opposing electrical charges. For example, a first dipole electrode can have a charge of +500 volts relative to a second dipole electrode within the same dipole assembly. In another example, the first dipole electrode can have a charge of +500 volts and the second dipole electrode can have a charge of −500 volts, both measured relative to a reference potential, such as a ground potential. Other electric potentials for dipole electrodes are possible and envisaged in this disclosure, such as potentials up to a charge of +300,000 volts on the first diode electrode and −300,000 volts on the second diode electrode.

In some embodiments, the rotatable portion of a dipole assembly can be an aperture or hole that accepts or receives a shaft, the shaft adapted to cause the dipole assembly to rotate. In other embodiments, a dipole assembly can be rotated by a rotatable portion on an outer edge or circumference of a dipole assembly, for example a plurality of gear teeth, or a groove suitable for being driven by a belt. The rotatable portion enables the dipole assembly to rotate relative to one or more stator electrodes in proximity to the dipole assembly.

Some embodiments of a capacitive alternator include more than one dipole assembly, where the respective dipole assemblies can be electrically isolated from one another. For example, more than one dipole assembly can be arranged along a common shaft to rotate in unison, but be electrically isolated from one another, and from the shaft.

The one or more stator electrodes may be arranged in stator assemblies where each member of the assembly is in electrical communication with the other members of the assembly. The stator assemblies can be electrically isolated from one another. In some embodiments a stator assembly can be configured into an assembly by electrically connecting one or more stator electrodes with a common output electrode. For example, there can be one assembly of stator electrodes arranged with a common output electrode that acts as one pole of an electrical output of a capacitive alternator, and another assembly of stator electrodes arranged with another common output electrode that acts as a second pole of an electrical output of a capacitive alternator.

In other embodiments, a capacitive alternator can be adapted to output power in more than one phase, where the output waveforms of sets of stator electrodes are shifted in phase from one another , such as three phase power. For example, there can be six stator assemblies arranged in three sets of two, electrically isolated from one another, each of the six assemblies having a common electrical output. The stator assemblies can be displaced at sixty degree angles relative to one another about the axis of the rotor. Dipole assemblies of the rotor can also be displaced at sixty-degree angles from one to the next. The six common output electrodes of the stator assemblies act as three sets of poles, two poles to a set of stator assemblies that are 180 degrees out of phase. Each of these three sets of poles would produce electrical signals that are 60 degrees out of phase from one another. A capacitive alternator according to this example produces a 3-phase electrical output.

The dipole assemblies and the stator electrodes can be arranged such that an electrical charge applied to the dipole electrodes induces a voltage and thus a current flow in the stator electrodes. For example, a dipole assembly can be rotatable in a plane parallel to a plane one of the plurality of stator electrodes. When the rotor is rotated, the induced voltage in the stator electrodes may take the form of a sinusoid. In this way a capacitive alternator can convert a direct current (“DC”) charge applied to the dipole electrodes into an alternating current charge induced on the stator electrodes and output from the capacitive alternator via the poles formed by the output electrodes.

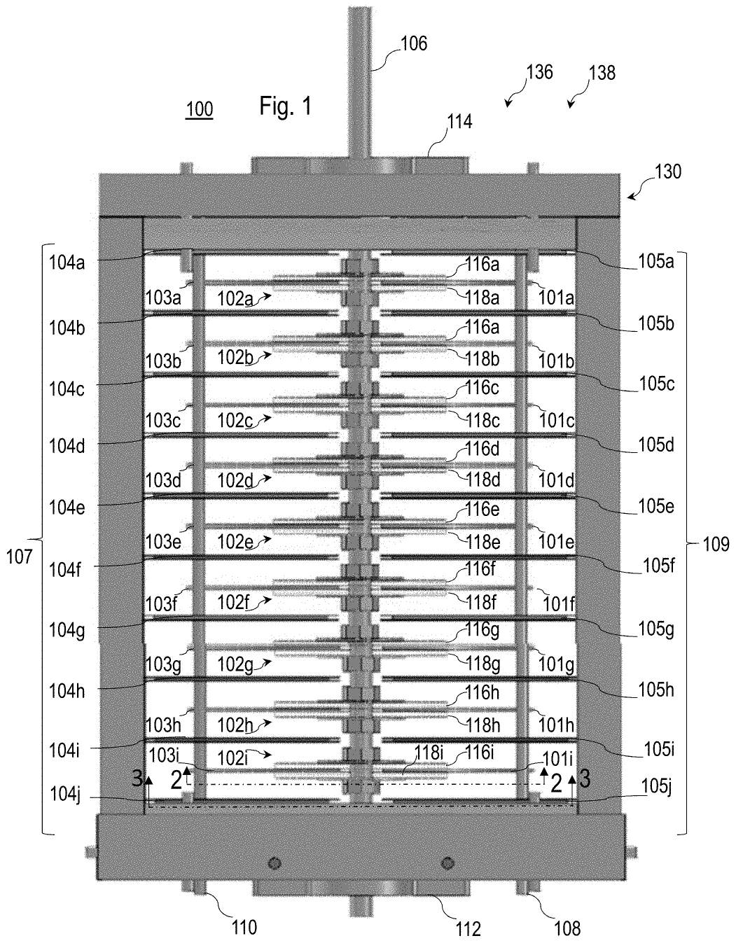

Turning to the figures, FIG. 1 shows a top view of an embodiment of a capacitive alternator 100. In this embodiment, the capacitive alternator 100 has a frame 130 that holds a rotor 136 with nine dipole assemblies 102a-102i, a stator 138 with two stator assemblies 107,109, a shaft 106, and two bearings 112,114. Each of the dipole assemblies 102a-102i is arranged on the common shaft 106, but are electrically isolated from one another, from the shaft 106, and from the stator assemblies. The stator assembly 107 includes a plurality of stator electrodes 104a-104j, and output electrode 110. The stator assembly 109 includes a plurality of stator electrodes 105a-105j and an output electrode 108. Each of the stator electrodes 104a-104j within the stator assembly 107 are in electrical communication with one another, and the respective output electrode 110 Likewise, each of the stator electrodes 105a-105j within the stator assembly 109 are in electrical communication with one another, and the output electrode 108. However, the stator assemblies 107 and 109, and their respective components, are electrically isolated from one another, from the frame 130, and the plurality of dipole assemblies 102a-102i. For example, the stator assemblies can be mounted to a dielectric material which is in turn mounted to the frame. The stator assemblies can be fixed to the dielectric material, for example, with threaded rod and cooperating threaded nuts. The dielectric material can be fixed to the frame with fasteners such as machine screws and cooperating threaded nuts. The dielectric material in this embodiment electrically isolates the stator assemblies from the frame and from one another. Other embodiments could use hard plastics, silicone, ceramics, or any appropriate insulating material.

As shown in this embodiment, the plurality of dipole assemblies are interleaved between the respective plurality of stator electrodes 104a-104j, 105a-105j. In other embodiments, there may be more or fewer dipole assemblies depending on the desired capacitance, and energy to be stored in an embodiment of a capacitive alternator. Other embodiments can have an even or odd number of dipole assemblies and/or an even or odd number of stator electrodes.

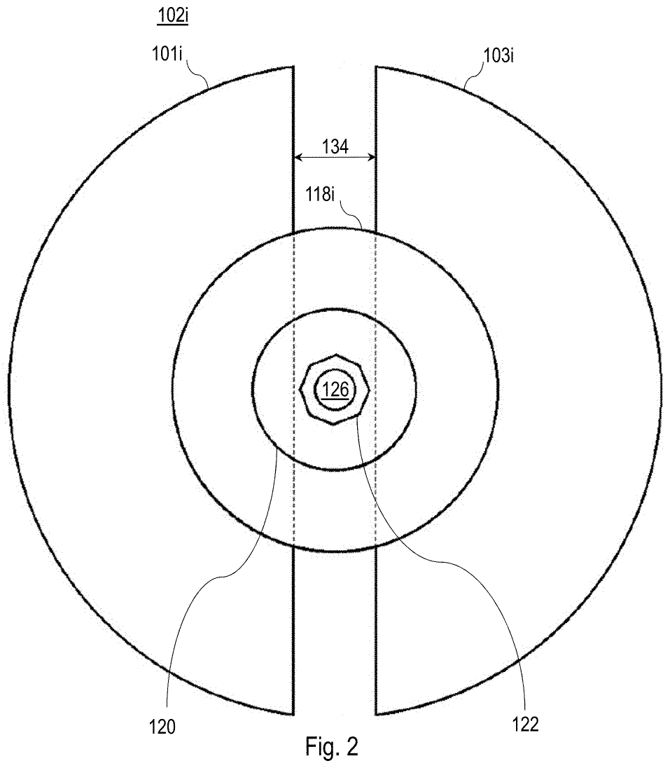

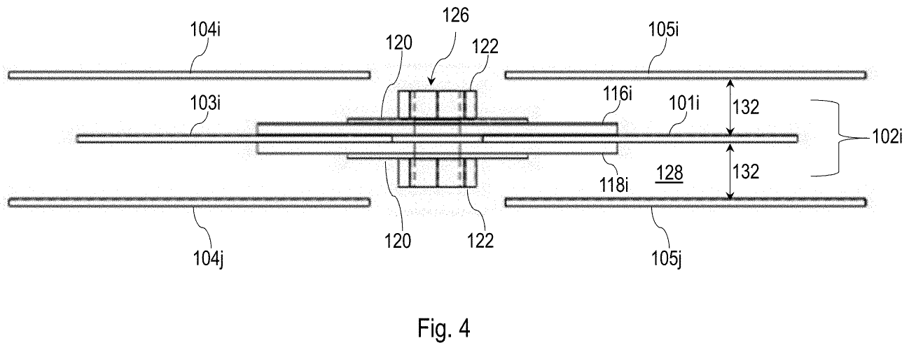

FIG. 2 shows a partial sectional view of a dipole assembly 102i of the embodiment of the capacitive alternator 100 of FIG. 1. The other dipole assemblies 102a-102h are substantially similar to the dipole assembly 102i, in this embodiment and will not be described separately, for the sake of brevity. In this embodiment, the dipole assembly 102i includes a first dipole electrode 101i and a second dipole electrode 103i. Other embodiments may include more dipole electrodes. The dipole electrodes 101i,103i are separated from one another by a gap 134 formed by two insulators 118i and 116i (116i not shown in FIG. 2). The insulators prevent mutual electrical communication between the dipole electrodes 101i,103i, and electrical communication between the respective dipole electrodes 101i,103i and the shaft 106, the frame 130, and the plurality of stator electrodes. The insulators 188i and 116i can be made of a rigid material in order to support the dipole electrodes 101i and 103i. For example, clear acrylic or polycarbonate can be fixed to the dipole electrodes, such as with an adhesive or mechanical fasteners such as screws, bolts or the like. Other embodiments could use other insulating or dielectric materials, such as rubber or other elastomer, thermoplastics, thermosets, acrylic, polycarbonate, glass, fiberglass composites, or ceramic. The insulators 116i,118i each have an aperture 126 defined in the body of the insulator through their thickness, adapted to receive the shaft 106. Positioned adjacent to each insulator 116i, 118i is a support member 120 and a securement member 122. As may best be seen in FIG. 4, the securement members 122, the support members 120, the insulators 116i,118i, and the dipole electrodes 101i,103i are arranged in a sandwich structure, secured by the securement members 122, to form the dipole assembly 102i. In various embodiments, the support member 120 is a washer, sheet, or other structural component that can spread compressive forces imparted by the securement members 122 on the insulators 116i, 118i. In this embodiment, the shaft 106 is a section of threaded rod, and the securement members 122 are cooperating threaded nuts that can thread onto the rod 106 to compress, locate, and secure the balance of the components of the dipole assembly 102i to the threaded rod 106.

The dipole electrodes 101a-101i and 103a-103i in this embodiment are formed sheets of a metal such as aluminum. In various other embodiments, the plurality of dipole electrodes can be made from any suitable electrically conductive material, such as other metals like copper, bronze, titanium, steel, iron, or the like, or alloys thereof with other metals. The dipole electrodes can also be formed from carbon, carbon alloys, or carbon composites. The dipole electrodes can be made of magnetic materials, magnetizable materials (e.g., iron), or materials that are neither magnetic nor magnetizable (e.g., aluminum). Although the dipole electrodes in the illustrated embodiment are in the form of semi-circular discs of a thin planar material, with a nominal thickness, other shapes are within the scope of this disclosure. In various examples, the plurality of dipole electrodes can be planar shapes that are rectangles, squares, triangles, other polygons, or irregular shapes. In various other examples, the plurality of dipole electrodes can be three dimensional shapes with a substantial thickness, such as cylinders, spheres, cubes, other polygonal shapes, or irregular shapes. Such three-dimensional shapes can be solid, they can be hollow shells, or shells of one material filled with one or more other materials.

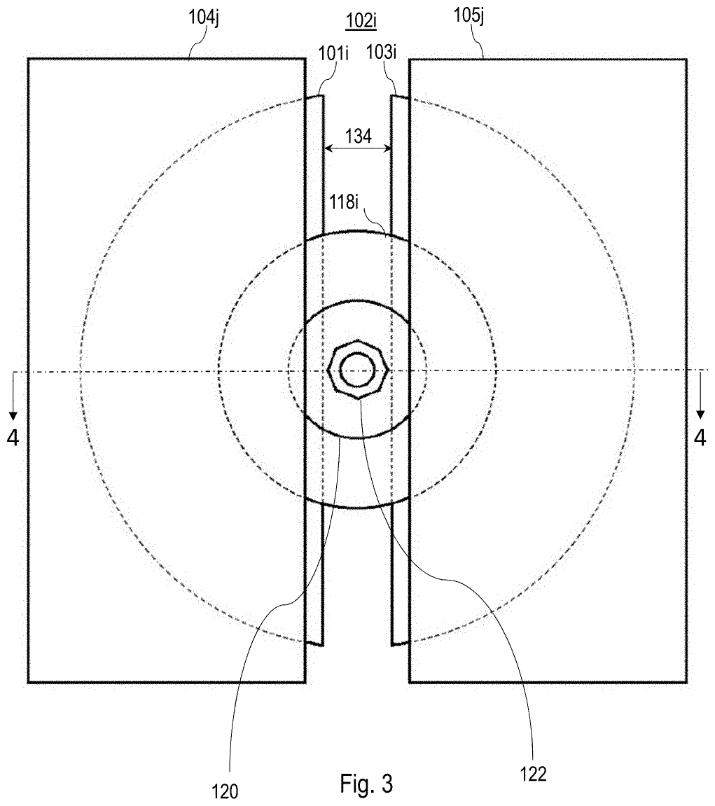

FIG. 3 shows a partial section view of the capacitive alternator 100 of FIG. 1 taken along section line 3-3. FIG. 3 shows the dipole assembly 102i in relation to stator electrodes 104j and 105j which are respectively members of stator assemblies 107 and 109. FIG. 4 shows a partial section view of the dipole assembly 102i and stator assemblies 107 and 109 taken along line 4-4 of FIG. 3. The view of FIG. 4 also includes stator electrodes 104i, 105i which are part of stator assemblies 107 and 109, respectively. As can be seen in FIGS. 3 and 4, the dipole electrodes 101i,103i are interleaved between the respective stator electrodes 104i,104j and 105i,105j, but separated from the stator electrodes by a gap 132 on either side. In the embodiment shown, the gap 132 between the dipole electrodes 101i,103i and the adjacent stator electrodes is substantially the same on both sides of the dipole electrodes. When the gap 132 on either side of the dipole electrodes is the substantially the same the force of the electric charge of the stator onto the electric charge of the dipole equals each other for a “Net of Zero”. This is because when two equal forces in opposite directions act upon an object the “Net Work” on that object is zero. This does not include the effects of the fringe fields which act at angles.

The gap 132 can be increased or decreased based on the potential that a capacitive alternator is designed to operate at. For instance, if a capacitive alternator is designed to operate at voltages that may cause arcing, the distance can be increased to prevent arcing. The gap 132 insulates the stator electrodes from one another and from the dipole electrodes. The gap 132 can be filled with a fluid 128 such as air, or it may have a vacuum. The size of the gap and the fluid within the gap 132 can be varied depending on the electrical potential applied to the capacitive alternator. For example, relatively low voltages may allow for smaller gaps 132, or the use of air as a fluid 128. With larger electrical potentials, electrical arcing may occur between components of the capacitive alternator that are insulated from one another. In those cases, larger gaps 132 and/or different fluids 128, or the lack of a fluid 128 (i.e., a vacuum) altogether may be used to prevent or lessen the chances of arcing.

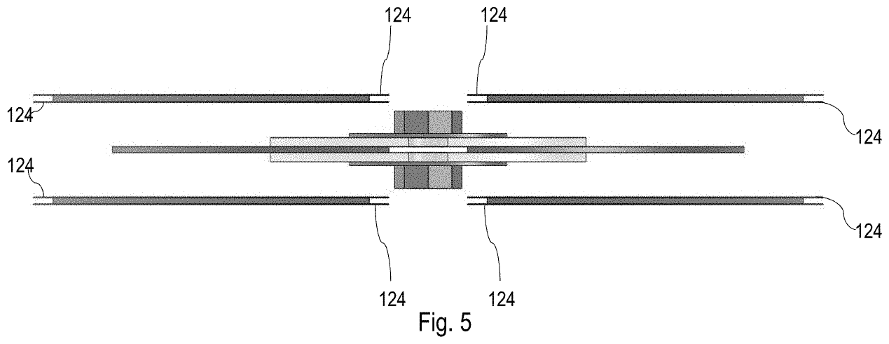

FIG. 5 illustrates an embodiment of a capacitive alternator in which the stator electrodes have an insulating material 124 applied to their surfaces. Such an insulating material 124 can reduce the chances of arcing from the stator electrodes to the dipole assemblies, or other parts of the capacitive alternator. This material 124 can be any electrically insulating material such as rubber or other elastomer, thermoplastics, thermosets, acrylic, polycarbonate, glass, fiberglass composites, or ceramic. In a preferred embodiment, the insulating material 124 is mica. The insulating material 124 increases the maximum voltage output of a capacitive alternator by providing added resistance to arcing during resonance when the stator electrodes can have a larger voltage than during non-resonance. The insulating material 124 can be much thinner than the gap 132. The material 124 used should have a larger electric breakdown strength than the fluid 128. The material 124 should also have as low of a relative permittivity as possible as to not restrict the force of the electric field of the dipole electrodes onto the stator electrodes and prohibit or reduce work. This layer of insulating material 124 also increases the capacitance of the stator as shown below. The capacitance C_{da} between stator electrodes 104i,j and 105i,j and the dipole assembly 102i can be represented by equation 1.

### Equation 1:

Where: ε₀ is the permittivity of a vacuum; ε₁₂₈ is the relative permittivity of the fluid 128; ε₁₂₄ is the relative permittivity of the insulating material 124; A_{da} is the surface area of each of the two dipole electrodes 101i,103i individually; d₁₃₂ is the gap between the dipole electrodes 101i,103i and the stator electrodes 104i,j and 105i,j; and d₁₂₄ is the thickness of the insulating material 124.

$${C}_{da} = ( 4 ) \cdot \frac{{ɛ}_{128} {ɛ}_{124} {A}_{da}}{{ɛ}_{128} {d}_{132} + {ɛ}_{124} {d}_{124}}$$

### Methods of Use

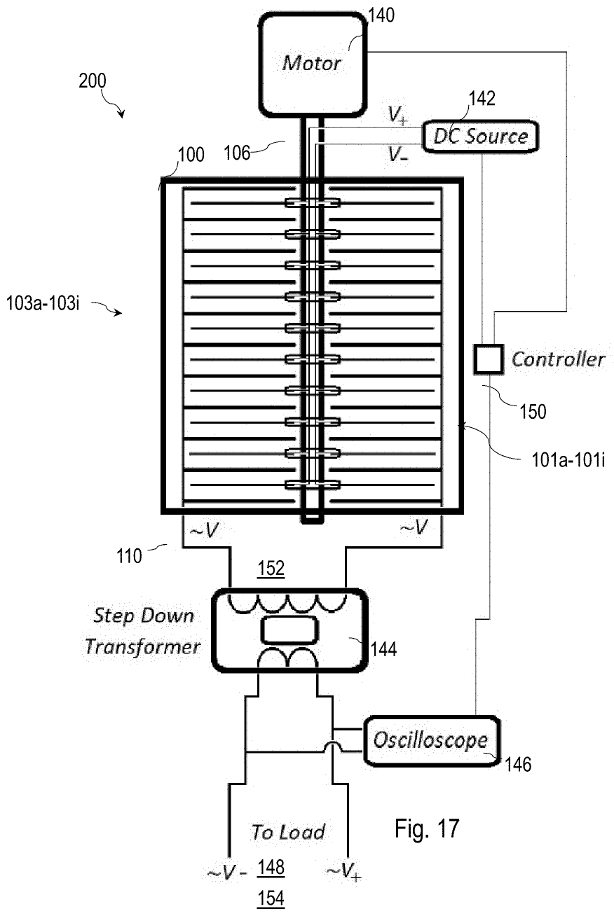

In one method of use, the respective dipole electrodes of the plurality of dipole assemblies can have an electrical potential imparted to them by an external electrical power source, such as DC source 142 as seen in FIG. 17. In one embodiment, a pulse transformer can be used to step up a relative low direct-current voltage, such as 6-12 V to a high level such as 500 kV or 1 MV. The output leads of the pulse transformer can be connected to opposing dipole electrodes within a given dipole assembly, imparting a potential to them. The process can be repeated with each dipole assembly in the capacitive alternator until all the dipole assemblies are charged. In other embodiments, a power source can be in substantially continuous electrical communication with the dipole electrodes 101a-101i and 103a-103i. A prime mover 140, such as a motor, engine or the like can be attached to the shaft 106 to impart a torque on the shaft 106 sufficient to cause it to rotate, and thereby rotate the dipole assemblies relative to the stator assemblies. The rotation along with the electrical potential imparted to the dipole electrodes induces an alternating voltage, such as a sinusoidal voltage, in the stator assemblies. This voltage will cause a current to flow if a circuit or load is connected across the output electrodes 108,110. The load can be a resistive load, an inductive load, a capacitive load, a semiconductor load, or a load with combinations of these characteristics. The capacitive alternator yields an output voltage proportional to the difference in voltage between the dipole electrodes, the capacitance (i.e., the parallel capacitance of the plurality of stator electrodes and dipole assemblies) of the device, the angular rotation of the rotor, and the resistance of the primary circuit based on the charging/discharging model of a capacitor in a direct current circuit. Thus, a capacitive alternator can convert direct current electrical energy to alternating current (“AC”) electrical energy.

Depending on the resistance, inductance, and capacitance of the load and similar properties of the capacitive alternator, as well as the voltage of the dipole electrodes and the rotational speed of the rotor, the capacitive alternator may be in resonance, when the AC voltage is in phase with the AC current at the output electrodes. When in resonance, the reactive power of the resulting circuit may be minimized. It may be desirable to minimize reactive power to reduce losses in the AC circuit from heating and the like. For example, it is possible to reduce the amount of inductance needed to bring the combined load and capacitive alternator circuit into resonance by adding more dipole assemblies 102, dipole assemblies 102 with larger surface areas, and/or reducing the distance 132 between the dipole assemblies 102 and the stator electrodes 104,105.

In some embodiments of methods of use, a capacitive alternator can be used to measure the angular velocity and/or acceleration of a shaft in rotational communication with the shaft 106. Due to its low resistance to rotational motion made possible by the lack of magnetic or inductive elements within, the capacitive alternator can be used to measure changes in rotation of a shaft with minimal effect on the shaft's rotation. For example, signal meter 146 such as a multimeter, oscilloscope, or similar meter can be used to display the frequency of the sine wave produced by the machine between the output electrodes 108,110, when the shaft 106 is connected to the rotating shaft whose speed is to be measured. Magnetic type alternators are used for this purpose already, however, a capacitive alternator machine would provide measurement with less resistance to rotation and possibly a more accurate measurement.

Similarly, a capacitive alternator can be used to measure a change in angular velocity with respect to time (angular acceleration) of a rotating shaft. When the rotor 136 is accelerated from rest or from a lower angular velocity to a higher steady angular velocity, the stator 138 experiences a spike in voltage for the duration of acceleration. While the rotor 136 is moving at its steady state constant speed, a lower difference in voltage (e.g., as measured by a root-mean squared or RMS value of an AC waveform) is produced between the stator assemblies 107,109. Finally, when the rotor 136 is decelerated, the stator 138 again experiences a spike in voltage above that of the steady state voltage before falling to zero when the rotor 136 is at rest. Therefore, a capacitive alternator can be used to measure the acceleration and deceleration of a rotating shaft in rotational communication with the shaft 106.

In one embodiment, a capacitive alternator may be adapted to enhance the ability of the capacitive alternator to measure shaft acceleration. In such an embodiment, the stator electrodes are made of one material, for example copper, while in the dipole assembly one dipole electrode is made of a material with one electronegativity, and another dipole electrode is made of another material with a different electronegativity. For example, one dipole electrode may be made from titanium and another dipole electrode made from aluminum. These dissimilar metals have different electronegativities, with aluminum being about 1.61, and titanium being about 1.54. Dipole electrodes made of such metals establish a difference in voltage between themselves and the stator electrodes. This established difference in voltage eliminates the need of an external DC supply used in other embodiments. When a torque is supplied to the shaft 106 of the rotor, the dipole assemblies 102 rotate which establishes an alternating voltage between the stator electrode outputs due to the difference in voltage established by the two different materials. A change in rotational position with respect to time of the rotor assembly can therefore be detected on the electrodes of the stator assemblies as an alternating voltage as the shaft is made to rotate, accelerate, and/or decelerate.

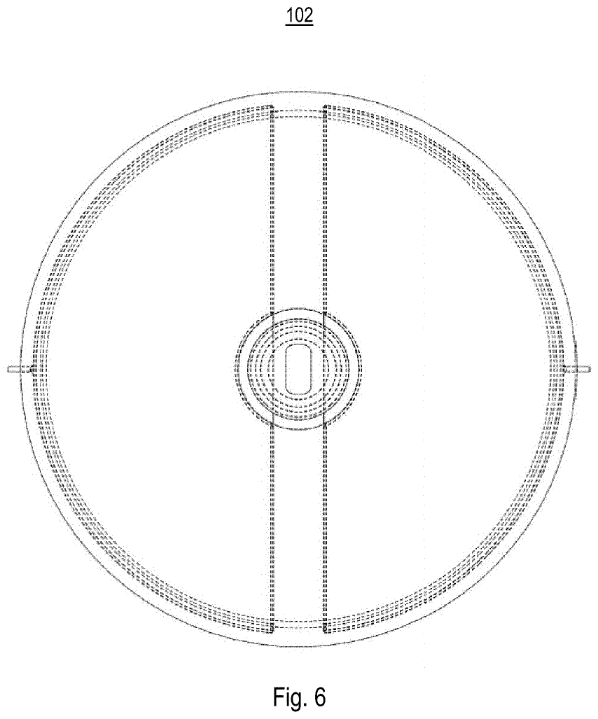

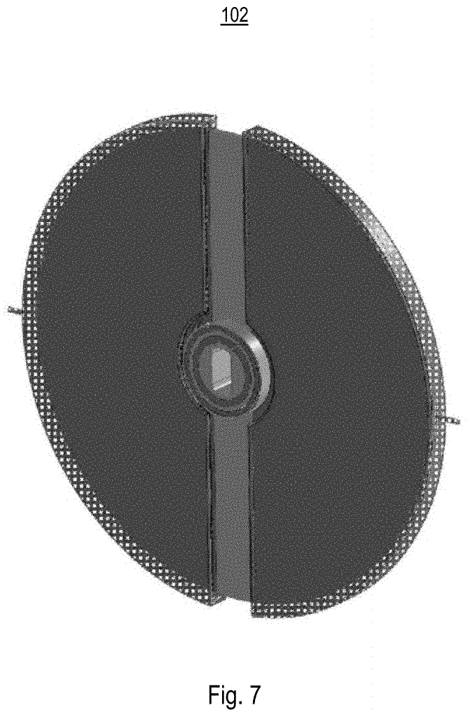

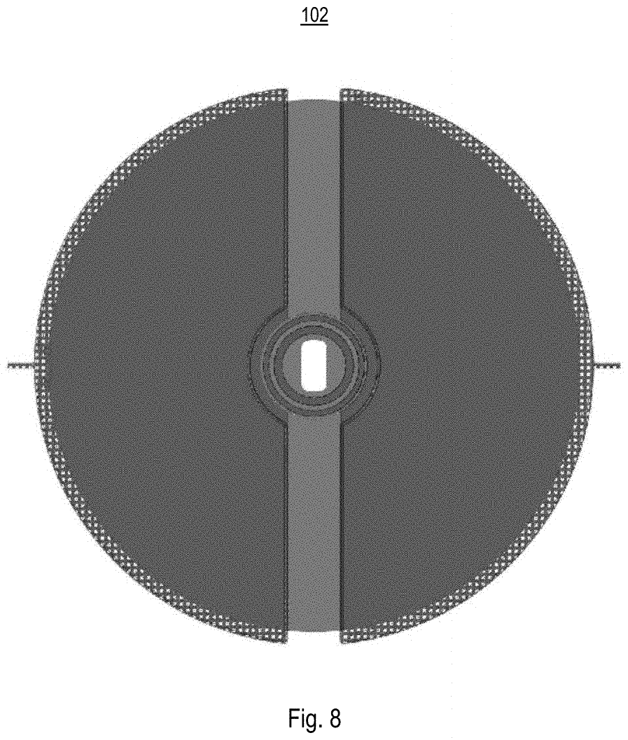

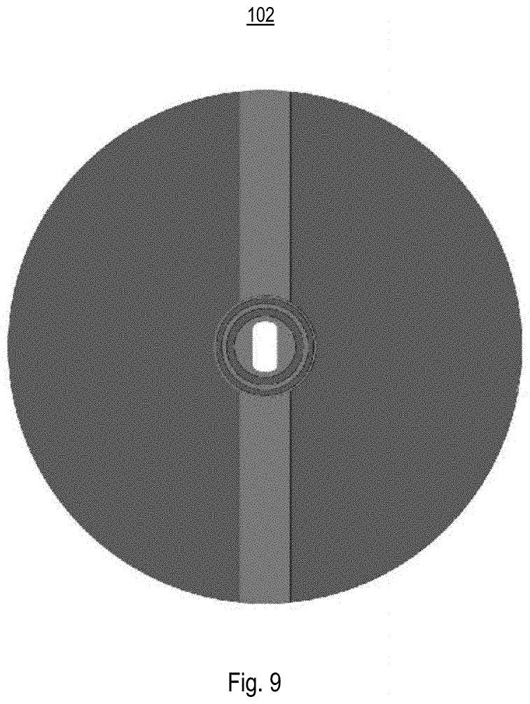

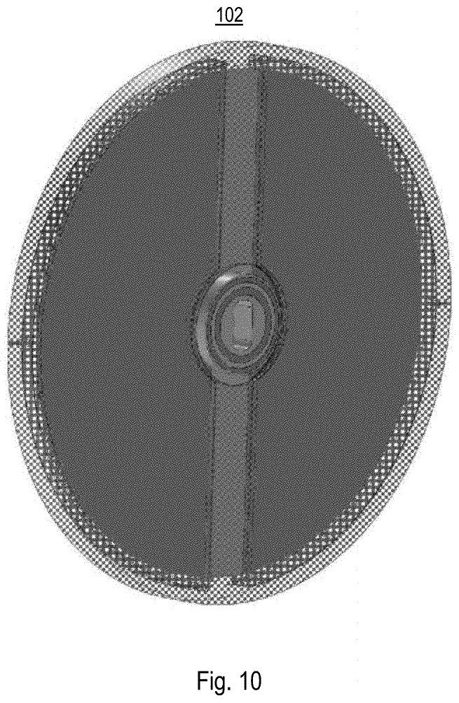

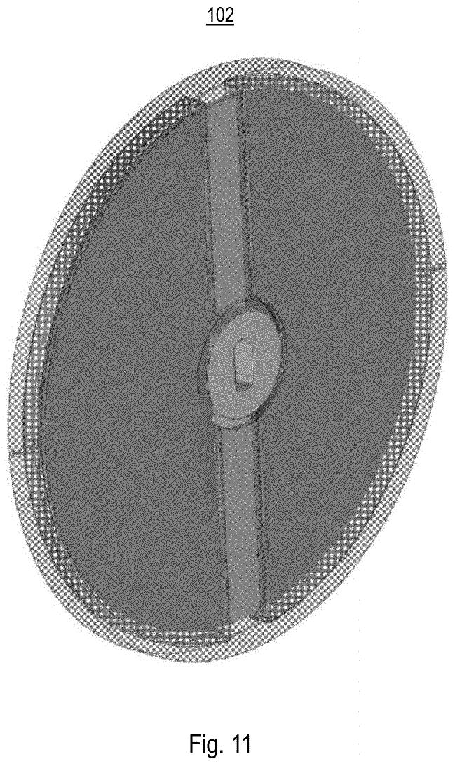

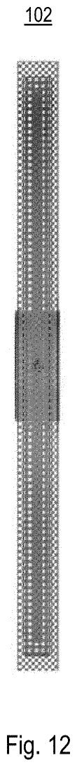

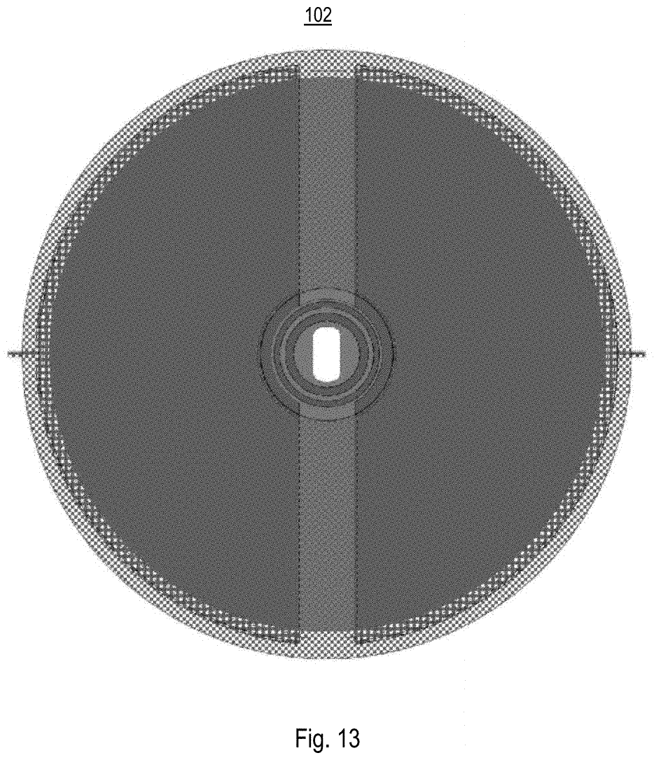

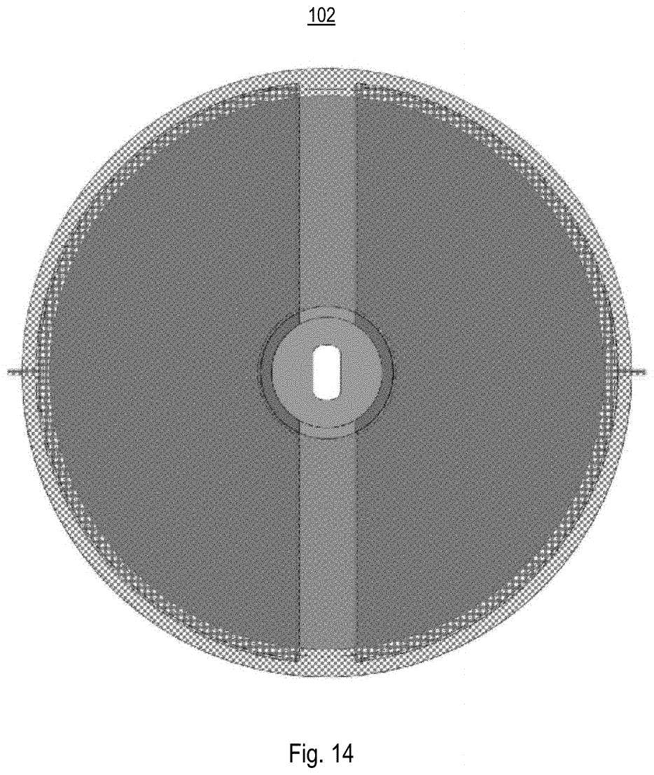

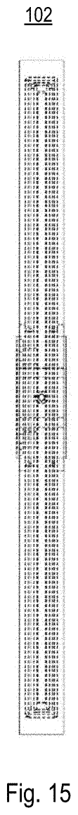

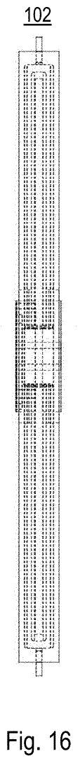

A dipole assembly 102 of an embodiment of a capacitive alternator suitable to measure rotational parameters of a shaft is shown in FIGS. 6-16. This embodiment, which is also known as a rotating electric field alternating current generator, is comprised of two sets of two semicircular discs and two rotatable dipole electrodes of different materials interleaved between the semicircular discs. Each of the semicircular discs of the stator assemblies share electrical communication with each other. But, each stator assembly is electrically isolated from each other stator assembly. Each stator assembly has an output electrode that can be connected to an electronic sensor. A sensor could be a multi-meter, an oscilloscope, a controller or any other device able to measure an electrical parameter. When enough torque is supplied to the shaft 106 of the rotor to establish rotation of the rotor an alternating current will flow between the stator assemblies and through the electronic sensor. The alternating current is established by the change in Volta potential across the stator electrodes with respect to time. The electrical parameter measured with the electronic sensor can be used to measure a rotational parameter of the shaft. In FIGS. 10-16 a layer of electrical insulation has been applied to the stator of the rotating electric field alternating current generator. The electrical insulation can provide a more stable electrical signal to the measuring device in order to measure the rate of rotation more accurately.

FIG. 17 shows an embodiment of a system 200 that includes a capacitive alternator 100, a prime mover 140, a power source 142, a controller 150, a signal meter 146, a transformer 144, and a load 148.

In various embodiments of the system 200, the power source 142 can be a battery, either primary or secondary; a photovoltaic panel or array of photovoltaic panels; a rectifier (i.e., an AC to DC converter); a DC to DC converter; a fuel cell; a generator; turbine such as a wind turbine; or any other suitable source of direct current electrical power. The power source 142 is in substantially continuous electrical communication with the dipole electrodes 101a-101i and 103a-103i supplying a substantially continuous charge. In the embodiment shown, the negative output of the power source 142 is in communication with dipole electrodes 101a-101i, and the positive output is in communication with the dipole electrodes 103a-103i, but other arrangements are contemplated.

The prime mover 140 imparts torque to the shaft 106 causing it and the rotor to rotate, thereby inducing an output waveform 152 with an AC voltage and current on the output electrodes 108, 110, as previously described. The output waveform 152 from the capacitive alternator 100 can be fed into a transformer 144, such as a step-down transformer that converts the waveform to an adapted output waveform 154 with a suitable voltage and current level to adapt the output waveform for use by a load 148. In other embodiments, the output waveform 152 can be fed into a step-up transformer, or other suitable interface device.

The controller 150 may contain one or more processing elements, a clock, a power module, storage, memory, a user input/output (“I/O”) interface, and/or a machine I/O interface. Each of the various elements may be in communication, either directly or indirectly. The processing element is substantially any electronic device capable of processing, receiving, and/or transmitting instructions, including a processor, or the like. For example, the processing element may be a silicon-based microprocessor chip, such as a general-purpose processor, CPU, GPU, programmable logic controller, or a proportional, integral, derivative (“PID”) controller. In another example, the processing element may be an application-specific silicon-based microprocessor such as a digital signal processor (“DSP”), an application specific integrated circuit (“ASIC”), or an application specific instruction-set processor (“ASIP”). In another example, the processor may be a microcontroller.

Storage may be any non-volatile computer readable media device. Examples may include: one or more magnetic hard disk drives, solid state drives, floppy disks, magnetic tapes, optical discs, flash memory, electrically erasable programmable read-only memory (“EEPROM”), erasable programmable read-only memory (“EPROM”), ferromagnetic RAM, holographic memory, printed ferromagnetic memory, or non-volatile main memory.

The memory may be any volatile computer readable media device that requires power to maintain its memory state. In one example, memory is random access memory (“RAM”). Other examples may include dynamic RAM, and static RAM. In one example, memory and/or storage store electronic data used or created by a processing element. Either the memory or the storage can contain computer-readable instructions that can be read by the processor and enable the processor to make decisions about output or control parameters based on the input data or internal calculations.

The user I/O interface may be any device that provides for input or output that can interface with a user, such as a liquid crystal display (“LCD”); a light emitting diode (“LED”) display; an audio generator such as a speaker; a haptic device that communicates via the sense of touch such as one or more input buttons and/or one or more eccentric rotating mass vibration motors.

The machine I/O interface provides communication to and from the controller 150 as well as other devices. The machine I/O interface can include a communication interface, such as WiFi, Ethernet, Bluetooth™, near field communication (“NFC”), radio frequency identification (“RFID”), infrared, or the like, as well as other communication components such as universal serial bus (“USB”) cables or receptacles, or similar physical connections using conductive wires or fiber optic cables.

A signal meter 146, such as an oscilloscope or other electrical sensor can monitor the adapted output waveform 154 from the transformer 144 or the output waveform 152 from the capacitive alternator 100 and generate data concerning the output waveform 152 and/or the adapted output waveform 154. That data can be sent to, read by, or received by the controller 150. The controller 150 can use the data to control the DC power source 142 (e.g., by changing either or both of the output current or voltage). The controller 150 can also use the data to control the prime mover 140 (e.g., by changing the motor speed, acceleration, deceleration, and/or direction). In this way, the controller can actively monitor and control the output from system 200.

A controller 150 can be used to control the output of a capacitive alternator. For example, the output of a capacitive alternator can be influenced by two inputs to maintain a given output. First, a difference in voltage from the rotor onto the stator, and second, a rate of rotation. The voltage from the rotor on to the stator will, by natural consequence decrease with time due to the ability of charges to travel across the electrical insulation supporting the dipole assemblies. Over time, the charges that establish this voltage may travel through the high resistance of the insulators 118 holding the dipole electrodes 101,103 to the shaft 106. A second issue arises when the torque required to maintain rotation is altered. When a greater load is present across the primary circuit (e.g., between the dipole electrodes 101,103) the charge held on the stator electrodes 104,105 is larger and therefore creates a greater amount of resistance to rotation of the rotor. The controller 150 can therefore be used to maintain the voltage output and rate of rotation of the rotor, when available.

The controller 150 can be used to maintain the voltage output of the capacitive alternator at a chosen rate of rotation with data collected from the oscilloscope or signal meter 146. The voltage, frequency, and current for example can be measured with an oscilloscope 146. The output voltage across the secondary (e.g., between output electrodes 108,110) can decrease over time as the charges on the rotor naturally dissipate. The oscilloscope 146 sends this voltage information to the controller 150 that then processes the data with a series of pass-fail logic gates. For example; if the output voltage is less than desired a signal is sent to the DC source 142 to charge the rotor, and when the voltage is equal to the desired output the signal is stopped and DC source 142 turns off by the controller 150.

Information about the rate of rotation is equal to the frequency of the output voltage. A changing frequency, could indicate that the resistive load across the primary circuit has changed. This change could increase the energy level between the stator and the rotor. Resistance to rotation is proportional to this energy level. During periods of greater current draw, the energy level between the stator and rotor can be greater. This could apply more torque against the rotor and therefore slow it down. A slower rate of rotation could bring the device out of resonance as well as reduce the voltage output. Also if being used for AC power generation, a slower rate of rotation would fail to be within the mandated frequency range of the electric grid. In order to compensate for this effect, the data regarding frequency and current can be transmitted to the controller 150 for processing in a manner similar to that mentioned above. A pass-fail circuit could, for example, tell a fuel injected bio-diesel engine to burn more fuel to compensate for the larger amount of torque against the rotor. This increase in fuel consumption would be directly maintained by the controller 150 via data from the oscilloscope 146.

The controller 150 can help maintain steady state electrical power output. The information collected by the oscilloscope 146 when passed to the controller 150 could be broadcasted to an external computer for monitoring and long-term analysis of the system.

Additional Examples

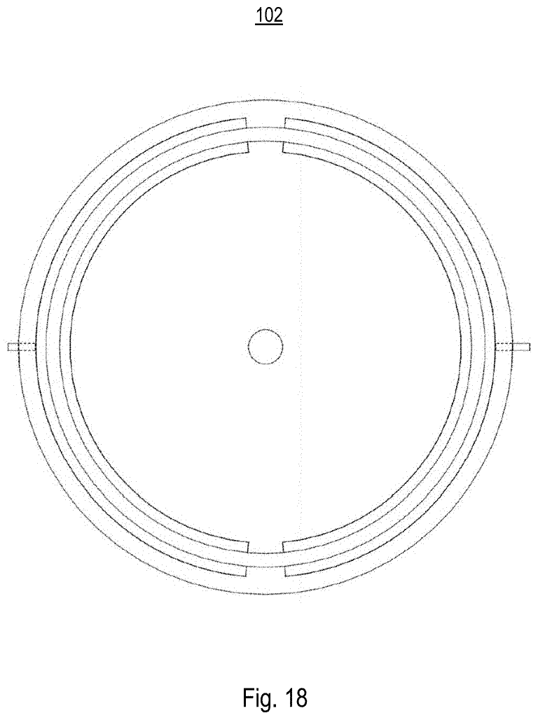

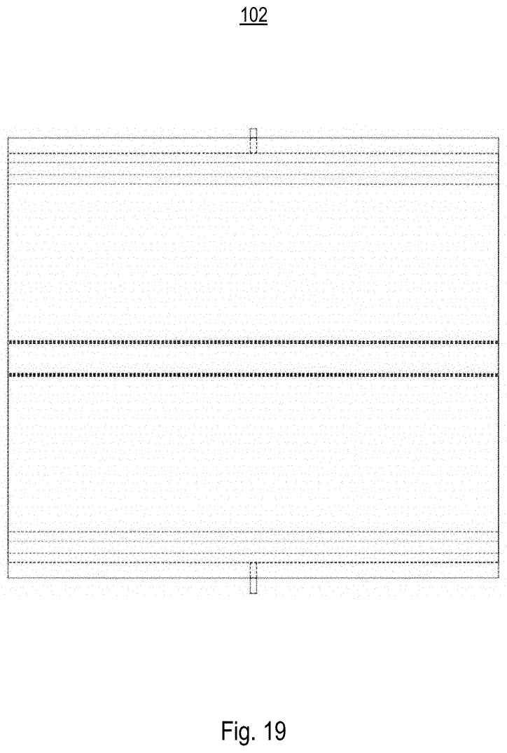

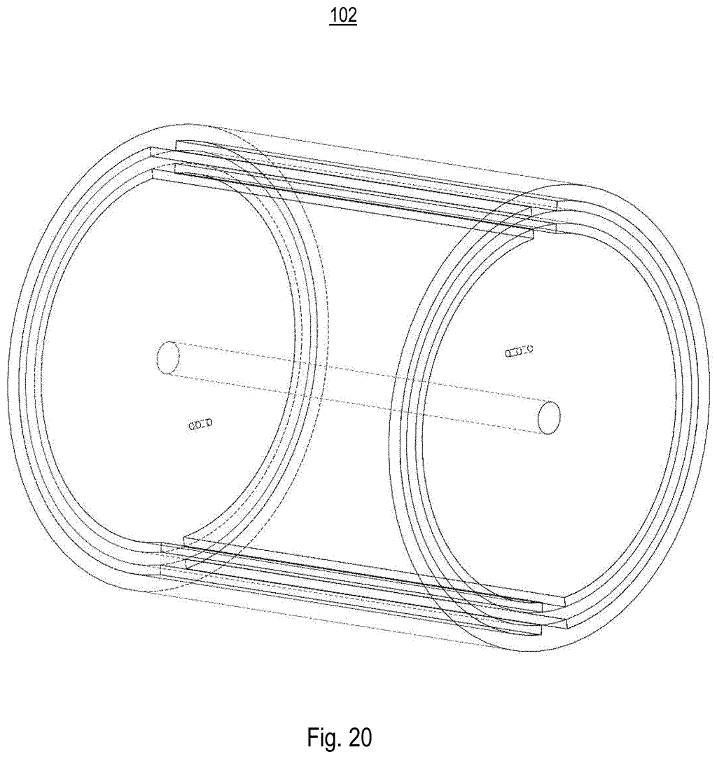

A dipole assembly 102 of an embodiment of a capacitive alternator is shown in FIGS. 18-20. In this embodiment, the dipole assemblies and stator electrodes are cylindrical in form. In one example, the capacitive alternator comprises two sets of half cylinders about a common axis and offset by a distance. The inner set of the half cylinders, divided along the axis, is separated by a solid dielectric material. This core both decreases the electric field between the two half cylinders and provides a rigid body which can be rotated with an axis. The outer set of the half cylinders, also divided along the axis, are held together with an insulator for structural support and electrical isolation. The outer set of half cylinders each have an electrical lead that connects the alternator to an electrical load. The inner cylinders are provided with opposite and equal electrical charges from a direct current circuit. This circuit includes diodes that allow the inner plates to gather charge and helps them resist discharging when the direct current is off. When the oppositely charged inner cylinders are rotated about the axis an alternating voltage is provided between the outer cylinders via the electrical load.

This alternating voltage is increased with respect to revolutions per time, charge density of the inner half cylinder set, length of the half cylinder sets, and the distance between the inner and outer sets. Increasing the radius of both sets of half cylinders proportionally does not change the output of the alternator, however by increasing the radius of the half cylinder sets proportionately a greater charge can be applied to the half cylinders due to their increased surface area. The capacitive alternator has a very high internal impedance. This creates an output that has predominately very high voltage and low amperage. However, the true power of the alternator can be very high depending on size of the alternator due to the fact that the voltage and amperage are in phase with each other.

The novelty of this form of electricity generation is such that there isn't a resistive torque against the rotation of the inner cylinder set during power generation. Wherein magnetic alternators always have an induced torque which is proportional to the rotational speed and opposite that of rotation. According to Lorentz Law: F=q(E+V×B) a voltage is established perpendicular to the velocity of a charge in a magnetic field and an opposite force is induced antiparallel to the velocity of that charge. The same Law demonstrates that if an electric field is set to rotate about an axis at the same velocity a voltage will be established on a charge parallel to that field. The opposite and equal reaction of this force is radial to the axis and does not produce a resistance against the rotation. Therefore, the constant mechanical energy of rotation required to operate a capacitive alternator is based on the mass of the inner cylinder sets rather than the mass of the rotor and the counter rotational force of electricity generation.

A dipole assembly 102 of an embodiment of a capacitive alternator is shown in FIGS. 6-16. In this embodiment, the rotating electric field alternating current generator is comprised of two sets of half circular plate capacitors and an additional rotating half circular leaf insert between them. This leaf has opposite electric charges on either hemisphere. Each set of half circular plates are connected to each other forming two capacitors in series. The leaf adds a parallel component to each set of capacitors and generates an alternating current within them while rotating. The two series capacitors have opposite voltages at any given time. The addition of two inductors of an appropriate size are added between the series capacitors to provide resonance at a desired frequency. A load circuit can be then added in series to these components which is then able to be supplied electrical power.

The ratio of the capacitive impedance of the plate capacitors over the internal resistance and external load resistance indicates that the mechanical input torque is amplified by the work done by the electric field within the capacitors. The mechanical work of rotation provides a mechanical advantage to the electrical energy stored in the electric field allowing it to create power over time.

An embodiment of the capacitive alternator of system 200 can be used to maintain the speed of a vehicle. The capacitive alternator can be attached to an axle of a vehicle directly, with gears or with belts. The rotation of the axle during normal vehicular motion can provide torque to the rotor of the capacitive alternator. The electrical wave function; such as voltage, current, and frequency can be sent to the controller 150 which in turn can be sent to the vehicle's on-board computer which manages the vehicle's speed control function. In addition, this embodiment of the capacitive alternator can produce electrical power while the vehicle is in normal motion. The electrical power generated by this system requires less torque than a magnetic alternator due to the direction of force in which the electric fields produce work relative to the plane of rotation of the rotor. The electrical power generated by this system can be supplied to an on-board electrical motor that in turn provides mechanical power back to the axle. This system therefore can supplement hybrid cars as well as electric powered cars alike. Magnetic type alternators are used for this purpose already, however, a capacitive alternator would provide measurement electrical power with less resistance to rotation and possibly with greater efficiency.

Increasing the radius of both sets of half cylinders proportionally increases the capacitance of the stator. An increase in capacitance in turn increases the electrical output of the machine per volt at a given rate of rotation. This embodiment of the capacitive alternator has a very high internal impedance. This creates an output that has a predominately high voltage and very low amperage. An appropriately sized inductor can reduce the internal impedance of the capacitive alternator. This embodiment can be easily adjusted to fit an axle that is already in use. The addition of this type of capacitive alternator to any type of rotating shaft can provide a time dependent electrical signal to a load or controller with little resistive torque. The low resistive torque comes from the conservative nature of electric fields, magnetic fields are non-conservative and require a lot of torque.

The novelty of this form of electricity generation is such that the resistive torque against the rotation of the inner cylinder or semicircular disc assemblies during electrical power generation is equal to the alternation of the electric energy within the capacitors. Wherein magnetic alternators always have an induced torque which is proportional to the magnetic field strength and the rotational speed of the rotor. The induced torque of the magnetic alternator opposes rotation yet is required for electrical power generation. As stated by Lorentz Law, a voltage is established perpendicular to the velocity of charges in a magnetic field and an opposite force is induced antiparallel to the velocity of such charges. The same law demonstrates that if an electric field is set to rotate about an axis a voltage will be established on charges parallel to that field. The opposite and equal reaction of this force is radial or normal to the axis depending on the embodiment, cylindrical or circular respectfully, and produces only a low amount of resistance against the rotation.

If the electric force of one stator electrode 104i and the force of another stator electrode 104j are equal but opposite in direction relative to the orthogonal plane of rotation of the rotor then the net force of both stator electrodes on the rotor would be zero. It is known however, that a conductive material within a capacitor requires an equal amount of mechanical work to remove the material that is equal to the change in electrical work induced within the capacitor. Therefore, the constant mechanical energy of rotation required to operate a capacitive alternator is based on the stored electrical energy between the rotor and stator during operation and the frictional resistance on the shaft of the rotor. This is in direct comparison to a magnetic alternator which requires constant torque to overcome the counter rotational force of electricity generation via magnetism as well as the frictional resistance on the shaft of the rotor.

The ability to produce electrical power more efficiently with the capacitive alternator relative to the magnetic alternator stems from the conservative nature of the electric field. Electric fields do work on charges that are parallel to their fields. Magnetic fields do no work on charges due to the fact that magnetic fields can only redirect charges based on the charge's relative perpendicular velocity to the magnetic field. The electrical output of the capacitive alternator is based on the strength of the electric fields held by the rotor assembly, the gap between the rotor assembly and stator assemblies, the rate at which the rotor assembly is made to rotate, and the electrical impedance that connects the output electrodes of the stator assemblies.

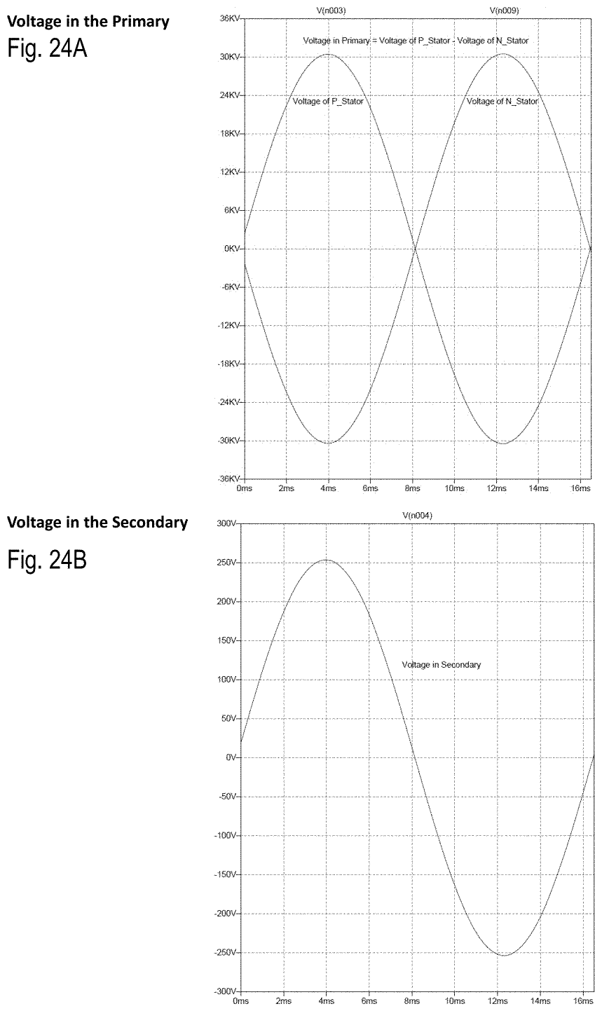

Due to the high internal capacitive reactance of the capacitive alternator an appropriately scaled inductor connected in series with the two stator assemblies will allow the circuit to reside in electrical resonance. While in resonance the current is subject to the resistive load of the circuit. In order to maximize electrical power output, the inductor mentioned above can take the form of a step-down transformer. The step-down transformer provides the inductance reactance to the primary circuit which is in series of the stator assemblies and it establishes a resistive load, that is equal to the square of the step-down ratio times the resistive load, onto the primary circuit. The resistive load can be very large when the step-down ratio is large. A large step-down ratio is also required to convert the often very high voltage of the primary, which can be up to or over 60 kilovolts, to a usable AC voltage of 240 volts as seen in FIG. 24. The step-down transformer brings the primary circuit into resonance as well as reduces the current flowing through the primary.

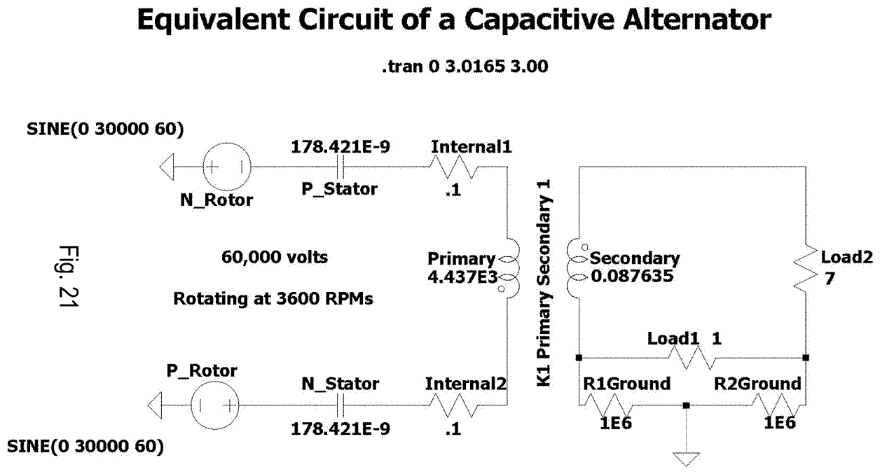

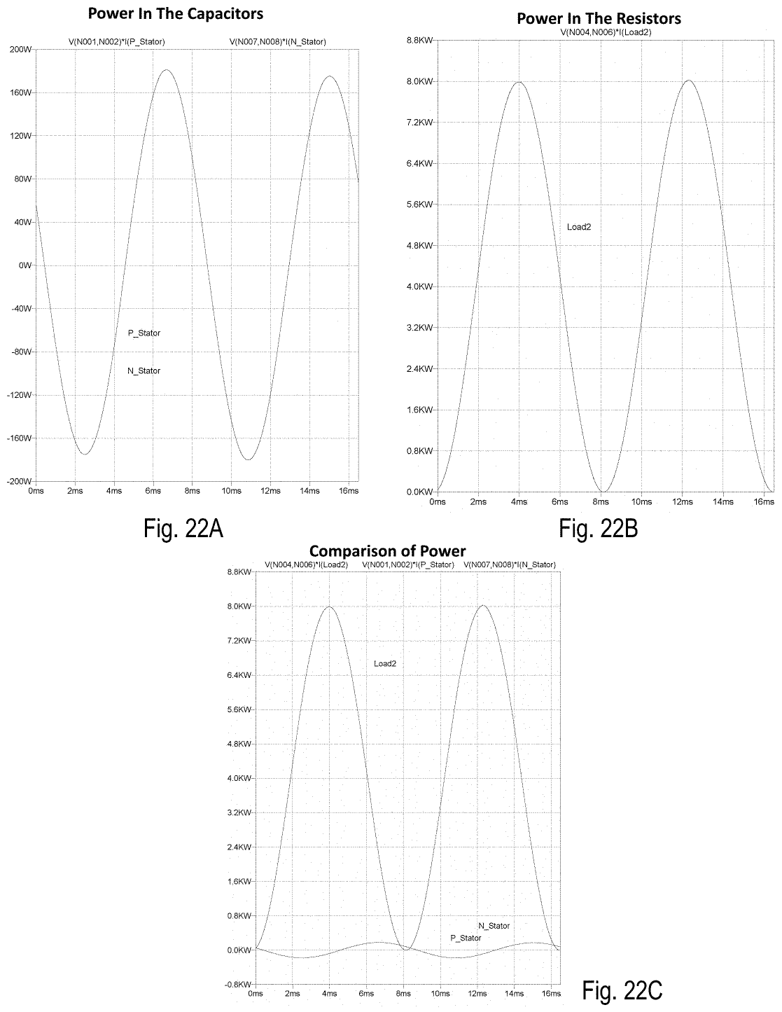

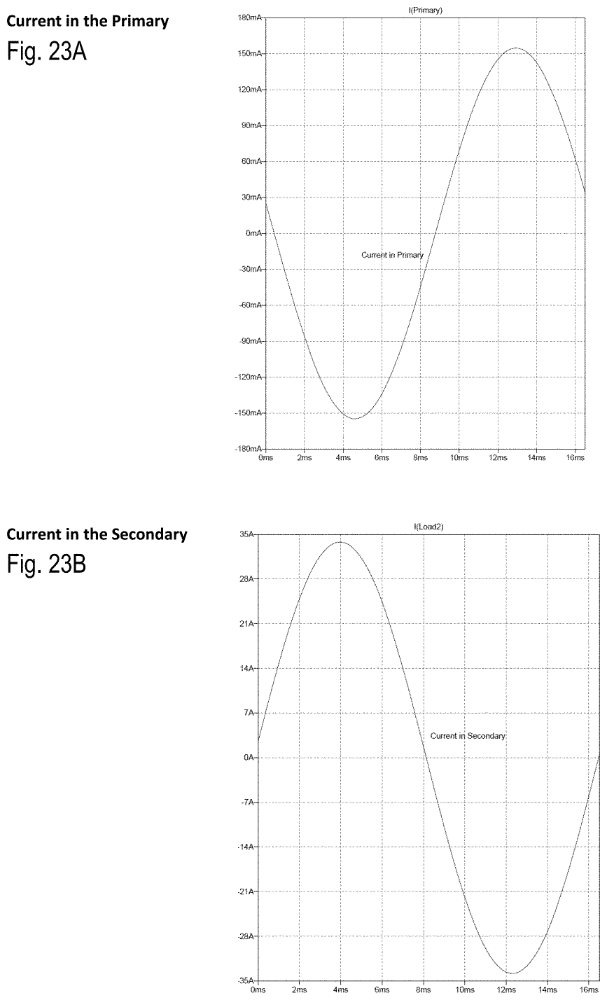

The amount of mechanical resistance to rotation is dependent on the electrical energy held between the rotor assemblies and the polarity of the stator assemblies. When the stepdown ratio of the transformer is appropriately sized the current and therefore the charge held on each of the stator assemblies can be very low. The corresponding charge density of the stator during resonance and that of the rotor establishes the electrical energy held between the rotor and stator. The amount of mechanical power that can alternate this electrical energy is proportional to the stored electrical energy within the capacitor times the angular rotation of the rotor. The electrical power flowing through the secondary of the transformer is equal to the voltage of the primary divided by the step-down ratio of the transformer and the current that is induced by the voltage of the secondary divided by the resistance of the load being supplied. This can be seen in an equivalent circuit of an embodiment of the capacitive alternator as in FIG. 21. Simulations of this equivalent circuit of FIG. 22 shows that the electrical power alternated within the capacitance of the stators can be magnitudes less than the electrical power alternating within the resistive load of the secondary circuit. FIGS. 23 and 24 further display the current and voltage, respectfully, alternating within the primary and secondary circuits of the equivalent circuit of FIG. 21. The equivalent circuit of FIG. 21 has derived quantities of capacitance and inductance from a mathematical analysis of an embodiment of the capacitive alternator.

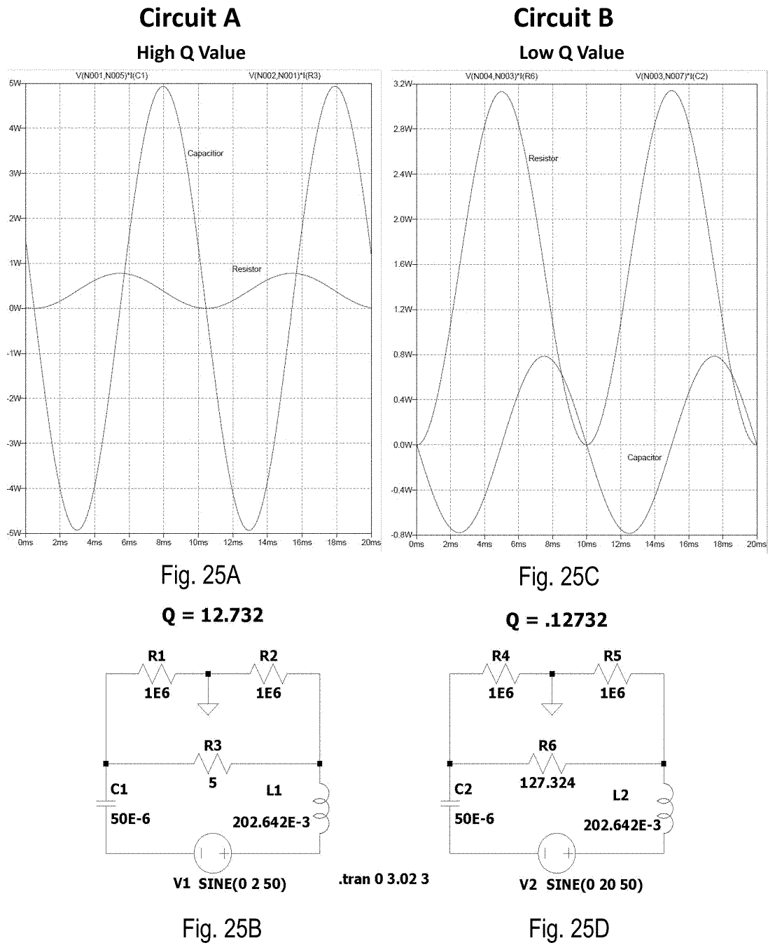

The relationship between the electrical power within the capacitance of the stator relative to the electrical power within the resistive load is related to the resonating circuit's quality factor (“Q”). In FIGS. 25A-D analyses of two similar resonant circuits is presented. The circuit of FIG. 25A and 25B has a Q value that is more than one, while the circuit of FIGS. 25C and 25D has a Q value that is less than one. A resonant circuit that has a Q value less than one has a greater amount of electrical power within the resistive load than within the capacitor. This shows that electrical components within a resonant circuit can experience various amounts of electrical power usage depending on the total impedance of the circuit.

In various embodiments, a capacitive alternator can establish a larger alternating electrical signal within a resistive load of a circuit than the equivalent mechanical power required to generate this signal by manipulating the electrical energy within the capacitance of the stator as seen in the Comparison of Power of FIG. 22. The mechanical resistance due to this form of electrical power generation is equal to the electrical power alternating within the capacitive electrodes of the stator during resonance when the Q value of the circuit is below one. This does not account for any mechanical resistances to rotation due to friction nor electrical power losses due to heat.

The above specifications, examples, and data provide a complete description of the structure and use of exemplary examples of the invention as defined in the claims. Although various examples of the disclosure have been described above with a certain degree of particularity, or with reference to one or more individual examples, those skilled in the art could make numerous alterations to the disclosed examples without departing from the spirit or scope of the claimed invention. Other examples are therefore contemplated. It is intended that all matter contained in the above description and shown in the accompanying drawings shall be interpreted as only illustrative of particular examples and not limiting. Changes in detail or structure may be made without departing from the basic elements of the invention as defined in the following claims.

All relative and directional references (including: upper, lower, upward, downward, left, right, leftward, rightward, top, bottom, side, above, below, front, middle, back, vertical, horizontal, right side up, upside down, sideways, and so forth) are given by way of example to aid the reader's understanding of the particular examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

I claim:

1. A capacitive alternator comprising:
a frame;
a shaft rotatably coupled to and extending through the frame;
a stator housed within the frame, the stator comprising a plurality of stator electrodes arranged in a first stator assembly and a second stator assembly such that
the stator electrodes in the first stator assembly are in electrical communication with one another, and
the stator electrodes in the second stator assembly are in electrical communication with one another; and
a rotor supported on and fixedly attached to the shaft such that rotation of the shaft causes a corresponding rotation of the rotor, the rotor comprising a dipole assembly, the dipole assembly comprising:
a first dipole electrode, and a second dipole electrode, wherein the first and second dipole electrodes are electrically isolated from one another, from the shaft, and from the stator electrodes, and wherein the dipole assembly is rotatable relative to one of the plurality of stator electrodes.

2. The capacitive alternator of claim 1, wherein a motor is coupled to the shaft and rotates the shaft and the rotor.

3. The capacitive alternator of claim 2, wherein the first dipole electrode is charged with an electrical potential relative to the second dipole electrode.

4. The capacitive alternator of claim 3, further comprising:
a first output electrode in electrical communication with the first stator assembly; and
a second output electrode in electrical communication with the second stator assembly.

5. The capacitive alternator of claim 4, wherein an alternating current waveform is induced between the first output electrode and the second output electrode.

6. The capacitive alternator of claim 2, further comprising a plurality of dipole assemblies.

7. The capacitive alternator of claim 6, wherein each of the plurality of dipole assemblies is interleaved between a respective two of the plurality of stator electrodes.

8. The capacitive alternator of claim 7, wherein when the rotor rotates, each of the first and second dipole electrodes of a respective one of the plurality of dipole assemblies alternately passes in proximity to the respective two of the plurality of stator electrodes.

9. The capacitive alternator of claim 8, wherein each of the plurality of dipole assemblies is further interleaved between another respective two of the plurality of stator electrodes.

10. The capacitive alternator of claim 9, wherein when the rotor rotates, each of the first and second dipole electrodes of a respective one of the plurality of dipole assemblies alternately passes in proximity to the another respective two of the plurality of stator electrodes.

11. The capacitive alternator of claim 10, wherein the each of the first dipole electrodes of the plurality of dipole assemblies is charged with an electrical potential relative to each of the second dipole electrodes of the plurality of dipole assemblies.

12. The capacitive alternator of claim 11, wherein the plurality of stator electrodes are thin sheets of material, and the dipole electrodes of the plurality of dipole assemblies are thin sheets of material.

13. The capacitive alternator of claim 12, wherein each of the dipole assemblies is rotatable in a plane parallel to a plane of one of the plurality of stator electrodes.

14. The capacitive alternator of claim 13, wherein:
the first dipole electrode of the plurality of dipole assemblies is made of a first electrically conductive material;
the second dipole electrode of the plurality of dipole assemblies is made of a second electrically conductive material; and
the plurality of stator electrodes are made of a third electrically conductive material.

15. The capacitive alternator of claim 5, wherein a step-down transformer is in electrical communication with the first and second output electrodes to form a primary circuit of the capacitive alternator and operable to:
reduce electrical current in the primary circuit; and
bring the primary circuit into resonance, wherein the primary circuit has a Q value less than one.

16. A method of using a capacitive alternator to measure a rotational parameter of a shaft comprising:
supplying a capacitive alternator comprising:
a frame,
a shaft rotatably coupled to and extending through the frame,
a stator housed within the frame, the stator comprising a plurality of stator electrodes arranged in a first stator assembly and a second stator assembly, such that
the stator electrodes in the first stator assembly are in electrical communication with one another, and
the stator electrodes in the second stator assembly are in electrical communication with one another,
a rotor supported on and fixedly attached to the shaft such that rotation of the shaft causes a corresponding rotation of the rotor, the rotor comprising a dipole assembly, the dipole assembly comprising:
a first dipole electrode, and a second dipole electrode, wherein the first and second dipole electrodes are electrically isolated from one another, from the shaft, and from the stator electrodes, and wherein the dipole assembly is rotatable relative to one of the plurality of stator electrodes,
a first output electrode in electrical communication with the first stator assembly, and
a second output electrode in electrical communication with the second stator assembly
rotating the shaft;
measuring an electrical parameter of an output waveform between the first output electrode and the second output electrode; and
correlating the electrical parameter to the rotational parameter.

17. The method of claim 16, further comprising:
applying an electrical potential between the first dipole electrode and the second dipole electrode, wherein:
the output waveform is a sinusoid;
the electrical parameter is a frequency of the sinusoid; and
the rotational parameter is a speed of the shaft.

18. The method of claim 16, further comprising:
applying an electrical potential between the first dipole electrode and the second dipole electrode, wherein:
the electrical parameter is a voltage spike; and
the rotational parameter is an acceleration of the shaft.

19. The method of claim 16, wherein the first dipole electrode is made of a material with a first electronegativity, the second dipole electrode is made of a material with a second electronegativity, and the first electronegativity is lower than the second electronegativity.

20. The capacitive alternator of claim 19, wherein the first material is aluminum, and the second material is titanium.
